(19) United States
(12) Patent Application Publication
(10) Pub. No.: US 2024/0154563 A1
(43) Pub. Date: May 9, 2024

(54) MOTOR DRIVING METHOD

(71) Applicant: SHINANO KENSHI KABUSHIKI KAISHA, Nagano (JP)

(72) Inventors: Takaaki MATSUDA, Nagano (JP); Jinichi TATSUNO, Nagano (JP); Eiji HIRACHI, Nagano (JP)

(21) Appl. No.: 18/486,245

(22) Filed: Oct. 13, 2023

(30) Foreign Application Priority Data
Nov. 8, 2022 (JP) 2022-178592

(51) Int. Cl. H02P 27/08

(52) U.S. Cl. CPC H02P 27/085; H02P 6/085

(57) ABSTRACT

A control circuit has a three-phase modulation operation mode under which a three-phase modulation signal is output to an inverter circuit as a pulse width modulation signal, a two-phase modulation operation mode under which a two-phase modulation signal is output to the inverter circuit as the pulse width modulation signal, and a transitional operation mode under which one of the three-phase modulation operation mode and the two-phase modulation operation mode is switched to the other. The control circuit transitions to the transitional operation mode in response to a reference signal set in advance, and switches an operation by outputting to the inverter circuit, a transition modulation signal with a mixture ratio between the three-phase modulation signal and the two-phase modulation signal being gradually changed in a predetermined electrical angle interval unit.

### CROSS-REFERENCE TO RELATED APPLICATION

This application is based upon and claims the benefit of priority of the prior Japanese Patent Application No. 2022-178592, filed on Nov. 8, 2022, and the entire contents of which are incorporated herein by reference.

### TECHNICAL FIELD

The present invention relates to a motor driving method enabling a three-phase motor to be driven while switching between a three-phase modulation operation mode and a two-phase modulation operation mode, using a pulse width modulation method.

### BACKGROUND ART

Conventionally, in some cases, a three-phase motor such as a three-phase brushless motor has been driven using pulse width modulation (PWM) control under which the operation thereof is switched between a three-phase modulation mode and a two-phase modulation mode based on a difference in timing of energization to the coil of each phase, with a hysteresis provided using a reference signal of some kind (such as a motor rotation speed or a duty ratio). With the PWM control, a switching pulse width of a switching element is variable, multiple pulse trains are generated in a single cycle of an output waveform, and a pulse width average voltage is output in a form of a sine wave.

Under the three-phase modulation mode, output voltages for three-phase coils are simultaneously modulated in a three-phase inverter circuit. Under the two-phase modulation mode, an output for one phase of the three-phase coils is fixed to High or Low, and the output voltages for the remaining two-phase coils are simultaneously modulated.

The two-phase modulation mode is advantageous in terms of energy efficiency. Specifically, the switching count as well as the calorific value of a switching element such as a FET can be reduced compared with those in the three-phase modulation mode. Still, the two-phase modulation mode involves a problem in that large noise is produced due to poor controllability during low-speed driving, and in that continuous ON time of a high-side FET at startup is restricted when a bootstrapping circuit is used.

When a two-phase modulation signal is used as a PWM control signal, a pulse width of the PWM signal falling below the minimum pulse width at motor startup, during the low-speed rotation, and the like leads to a failure to accurately turn ON or OFF the switching element, resulting in a state where the motor cannot be stably driven. To address this, a motor driving device (see WO2018/047236; PTL 1) of the following configuration has been proposed. Specifically, a controller calculates a pulse width modulation signal of a two-phase modulation format. When the minimum pulse width of the pulse width modulation signal calculated is smaller than a set value, the pulse width modulation signal calculated is corrected to a pulse width modulation signal of a three-phase modulation format with a minimum pulse width being equal to or larger than the set value and with an interphase voltage being the same as that of the pulse width modulation signal calculated. A switching element is driven to turn ON or OFF using the pulse width modulation signal as a result of the correction.

### CITATION LIST

### Patent Literature

PTL 1: WO2018/047236

### SUMMARY OF INVENTION

### Technical Problem

As a possible solution to overcome such a trouble, a startup operation at motor startup may be performed by a three-phase modulation operation, and the operation may be switched to a two-phase modulation operation in response to transition to an operation involving high rotation speed, high load, or high temperature. The operation thus switched between the three-phase modulation mode and the two-phase modulation mode may involve a difference in output by the switching. This may result in current fluctuation and noise.

Furthermore, without a sufficient hysteresis provided for a reference signal (such as the motor rotation speed or the duty ratio) for the operation switching, the operation switching may occur frequently, or the motor driving state may vary under a loaded state.

In particular, depending on the load on the motor and an operation condition of the inverter circuit, the rotation speed, torque, and the like of the motor may sharply fluctuate (vibration or mechanical/structural damage) before and after the switching between the two-phase modulation and the three-phase modulation. In view of this, a highly accurate rotation sensor may be provided and a strict operation switching condition may be set, but these respectively result in problems in that a cost increases and that the operation switching cannot be flexibly performed.

### Solution to Problem

The present invention has been made to solve various problems as described above, and an object thereof is to provide a motor driving method in which, for switching of an operation of a three-phase motor between a three-phase modulation operation mode and a two-phase modulation operation mode using a pulse width modulation method, a transitional operation mode is used under which a mixture ratio between a three-phase modulation signal and a two-phase modulation signal is changed, so that the operation can be switched smoothly.

In a motor driving method of driving a three-phase motor including a stator with three-phase coils, through sine wave energization using a pulse width modulation method, the three-phase motor includes an inverter circuit including an output element including a pair of a high-side arm and a low-side arm for each of three phases, and configured to perform an output to two phases of the three-phase coils, and a control circuit configured to control an output to the inverter circuit using a pulse width modulation energization method at a predetermined duty ratio based on an output command from an external command apparatus, and the control circuit has a three-phase modulation operation mode under which a three-phase modulation signal is output to the inverter circuit as a pulse width modulation signal, a two-phase modulation operation mode under which a two-phase modulation signal is output to the inverter circuit as the pulse width modulation signal, and a transitional operation mode under which one of the three-phase modulation operation mode and the two-phase modulation operation mode is switched to the other. The method includes, by the control circuit: transitioning to the transitional operation mode in response to a reference signal set in advance; and switching an operation by outputting to the inverter circuit, a transition modulation signal with a mixture ratio between the three-phase modulation signal and the two-phase modulation signal being gradually changed in a predetermined electrical angle interval unit.

When the operation of the three-phase motor is switched between the three-phase modulation operation mode and the two-phase modulation operation mode with the pulse width modulation method, the control circuit transitions to the transitional operation mode in response to the reference signal set in advance, and outputs to the inverter circuit, the transition modulation signal with the mixture ratio between the three-phase modulation signal and the two-phase modulation signal gradually changed in a predetermined electrical angle interval unit. Thus, the operation can be switched smoothly, whereby the motor can be stably driven even under a loaded state. In the transitional operation mode, the control circuit may alternately output the three-phase modulation signal or the two-phase modulation signal in a predetermined energization interval unit, with energization waveforms of the three-phase modulation signal and the two-phase modulation signal output being symmetrical about center of the predetermined energization interval.

Thus, under the transitional operation mode, the fluctuation due to an interphase voltage difference in the three-phase coils caused by the switching is balanced, whereby the operation can be switched with the motor driven in a stable state.

The control circuit may generate the three-phase modulation signal and output the three-phase modulation signal to the inverter circuit at time of startup, and output, when a rotation speed, load, or temperature becomes high, the two-phase modulation signal as a result of the transitional operation mode, to the inverter circuit.

Thus, by adopting the three-phase modulation with good controllability during low-speed driving and adopting the two-phase modulation with good energy use efficiency when the rotation speed, load, or temperature becomes high, stable operation during low-speed driving and energy saving during an operation involving high rotation speed, high load, or high temperature are both achieved, whereby noise during the entire operation can be lowered and energy use efficiency can be improved, specifically, the calorific value of a switching element can be reduced.

### Advantageous Effects of Invention

For the switching of the operation of the three-phase motor between the three-phase modulation operation mode and the two-phase modulation operation mode using the pulse width modulation method, the transitional operation mode is used under which the mixture ratio between the three-phase modulation signal and the two-phase modulation signal is changed. Thus, the operation can be switched smoothly, whereby a stable motor driving state can be maintained even under a loaded state.

### BRIEF DESCRIPTION OF DRAWINGS

FIG. 1 is a diagram illustrating voltage waveforms under a three-phase modulation operation mode.

FIG. 2 is a diagram illustrating voltage waveforms under a two-phase modulation operation mode.

FIG. 3 is a diagram illustrating voltage waveforms under a transition modulation operation mode.

FIG. 4 is a configuration diagram illustrating the voltage waveforms in the transition modulation operation mode in FIG. 3.

FIG. 5 is a diagram illustrating voltage waveforms with a mixture ratio between a three-phase modulation voltage and a two-phase modulation voltage being 100:0 under the transition modulation operation mode.

FIG. 6 is a diagram illustrating voltage waveforms with the mixture ratio between the three-phase modulation voltage and the two-phase modulation voltage being 90:10 under the transition modulation operation mode.

FIG. 7 is a diagram illustrating voltage waveforms with the mixture ratio between the three-phase modulation voltage and the two-phase modulation voltage being 50:50 under the transition modulation operation mode.

FIG. 8 is a diagram illustrating voltage waveforms with the mixture ratio between the three-phase modulation voltage and the two-phase modulation voltage being 10:90 under the transition modulation operation mode.

FIG. 9 is a diagram illustrating voltage waveforms with the mixture ratio between the three-phase modulation voltage and the two-phase modulation voltage being 0:100 under the transition modulation operation mode.

FIG. 10 is a block configuration diagram illustrating an example of a motor driving device.

FIG. 11 is a diagram illustrating voltage waveforms with the mixture ratio between the three-phase modulation voltage and the two-phase modulation voltage being 50:50 under the transition modulation operation mode in a unit of an electrical angle of 120 degrees.

FIG. 12 is a diagram illustrating voltage waveforms with the mixture ratio between the three-phase modulation voltage and the two-phase modulation voltage being 50:50 under the transition modulation operation mode in a unit of an electrical angle of 30 degrees.

### DESCRIPTION OF EMBODIMENTS

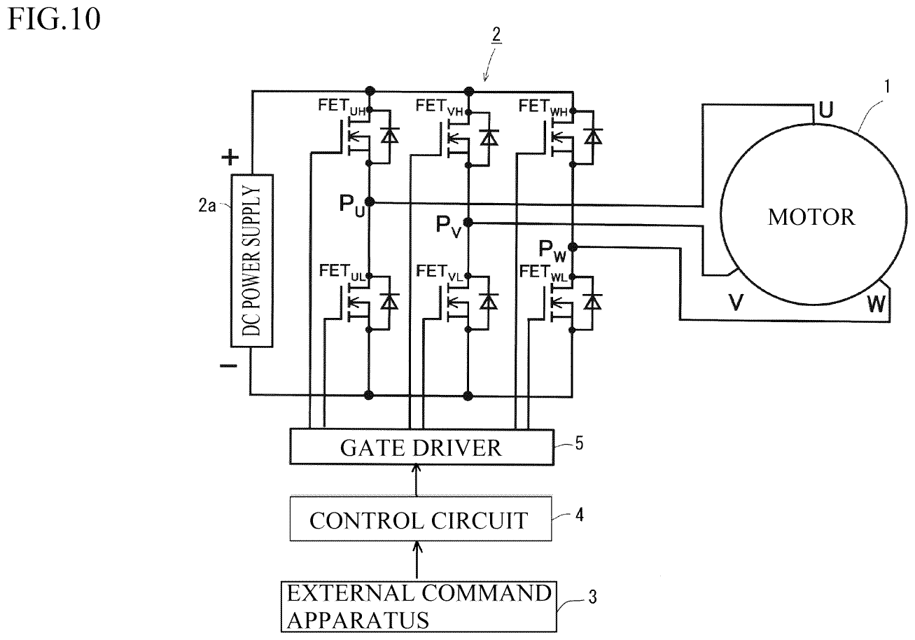

An embodiment of a motor driving method according to the present invention will be described below with reference to the drawings. An example of a motor driving device will be described with reference to FIG. 10. For avoiding complication, a description on a clock generator, a communication unit, a motor current detection circuit, and the like will be omitted. A three-phase brushless motor will be described as an example of a three-phase motor.

In FIG. 10, a three-phase brushless motor 1 includes, for example, a rotor as a permanent magnet field system, and a stator as a stator core in which pole teeth are disposed opposite to a permanent magnet with a phase difference corresponding to a mechanical angle of 120 degrees. A motor coil is wound around each of the pole teeth. Each of phase terminals of U phase, V phase, and W phase is connected to an inverter circuit 2. The inverter circuit 2 receives power supply from a DC power supply 2a. The motor coils may be in delta connection by which adjacent phases are connected with no neutral point. The three-phase brushless motor 1 may be of an inner rotor type or an outer rotor type. The permanent magnet field system may be any of an interior permanent magnet (IPM) motor or a surface permanent magnet (SPM) motor.

An external command apparatus 3 transmits a rotation command (RUN) to a control circuit 4 (MPU). The control circuit 4 incorporates a logical circuit (LOGIC), a PWM controller, a current amplifier, an AD convertor circuit, and the like not illustrated. The logical circuit stores an energization pattern for energization at an electrical angle of 180 degrees. The PWM controller generates a PWM control signal based on the energization pattern.

Upon receiving the rotation command from the external command apparatus 3, the control circuit 4 generates the PWM control signal using the logical circuit (LOGIC) and the PWM controller. The PWM controller transmits a DC gate signal to a gate driver 5. Upon receiving the gate signal, the gate driver 5 transmits a gate output with an amplified voltage to the inverter circuit 2. The gate driver 5 incorporates a charge pump circuit that boosts the gate output voltage, a through-current prevention circuit, and the like. The inverter circuit 2 is an inverter circuit of a three-phase half bridge configuration, in which a switching element (FET) of a high-side arm or a low-side arm of each phase is turned ON in response to an input of the gate output from the gate driver 5, and power-amplified coil voltage is output to the three-phase coils U, V, and W. A FET is used as the switching element incorporating a body diode.

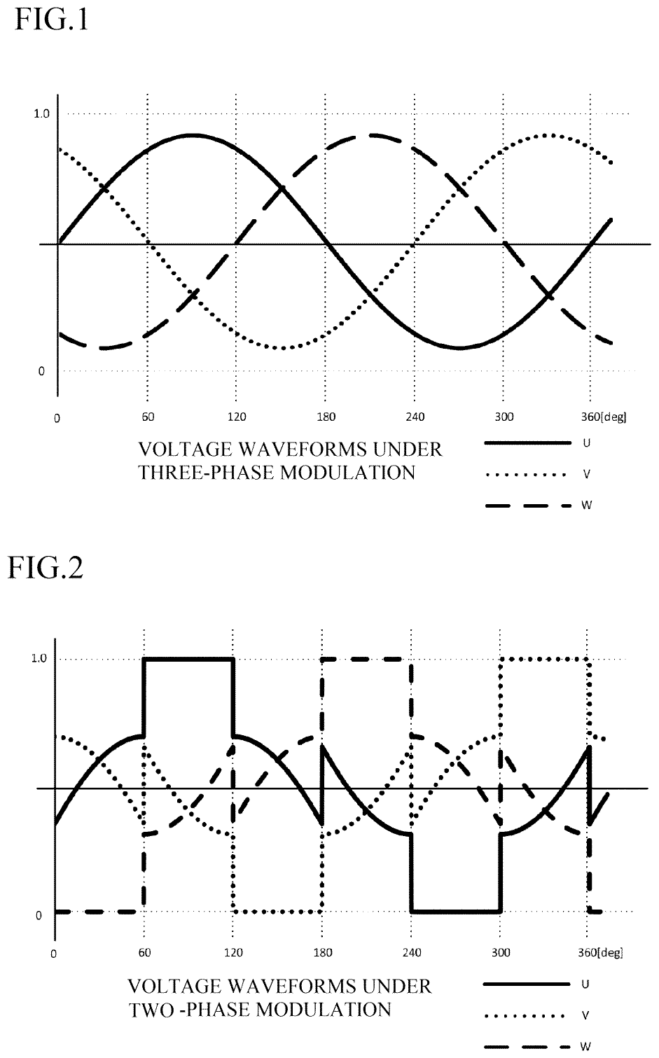

Next, an example of a motor driving method using the motor driving device described above will be described. As the motor driving method, an example is described in which a startup operation at motor startup is performed under a three-phase modulation mode, and in response to a reference signal (for example, the motor rotation speed) set in advance, the operation is switched to a transitional operation mode, and then to a two-phase modulation operation mode. The transitional operation mode during the transitioning of the operation from the three-phase modulation operation mode to the two-phase modulation operation mode will be described with reference to FIG. 1 to FIG. 9 that are diagrams illustrating voltage waveforms.

The three-phase brushless motor 1 performs a startup operation under the three-phase modulation operation mode at motor startup, and the operation is switched to the transition modulation operation mode and then to the two-phase modulation operation mode when the rotation speed, load, or temperature becomes high.

FIG. 1 illustrates waveforms of coil voltages applied to the motor coils under the three-phase modulation operation mode (waveforms of the average PWM-modulated voltage over a minute time). The solid line indicates the U-phase coil voltage, the dotted line indicates the V-phase coil voltage, and the broken line indicates the W-phase coil voltage. The PWM-modulated voltage is supplied to each phase, to obtain the average over a minute time in a form of a sine wave. Hereinafter, the “average PWM-modulated voltage applied to the motor coil over a minute time” is referred to as “average coil applied voltage”.

FIG. 2 illustrates waveforms of average coil applied voltages applied to the motor coils under the two-phase modulation operation mode. The two-phase modulation method (high-low method) is a method by which the voltage for one phase is fixed to High or Low only during a specific interval in one cycle of signal waves to be compared with a modulated wave in PWM control, whereas the voltages for the two remaining phases are modulated. For example, during an electrical angle interval of 60 to 120 degrees, the voltage for the U phase is fixed to High, and signals delayed by electrical angles of 120 and 240 degrees with respect to the U phase are respectively output to the V phase and the W phase. In a similar manner, during an electrical angle interval of 120 to 180 degrees, the voltage for the V phase is fixed to Low, and signals delayed by electrical angles of 120 and 240 degrees with respect to the V phase are respectively output to the U phase and the W phase.

Next, the transitional operation mode will be described with reference to FIG. 2 to FIG. 9 that are diagrams illustrating waveforms of the average coil applied voltages. As illustrated in FIG. 2, during the two-phase modulation operation, the interval in which any of the average applied voltages is 100% or 0% changes in a unit of an electrical angle of 60 degrees. Thus, as illustrated in FIG. 4 as an example of the transitional operation mode, while a single rotation occurs, in an electrical angle interval unit of 60 degrees, the average coil applied voltage waveforms are switched for a total of 12 times for the three-phase modulation signal and the two-phase modulation signal. Thus, under the transitional operation mode, the waveforms of the three-phase modulation signal and the two-phase modulation signal coexist. Under this condition, the transitional operation mode involves a change including a decrease in the proportion of the three-phase modulation signal and an increase in the proportion of the two-phase modulation signal, in an electrical angle interval unit of 60 degrees. Specifically, the mixture ratio between the three-phase modulation signal and the two-phase modulation signal gradually changes each time rotation of an electrical angle of 60 degrees occurs. Under the transitional operation mode for the transition from the two-phase modulation operation mode to the three-phase modulation operation mode, a change occurs to decrease the proportion of the two-phase modulation signal and increase the proportion of the three-phase modulation signal in an electrical angle interval unit of 60 degrees.

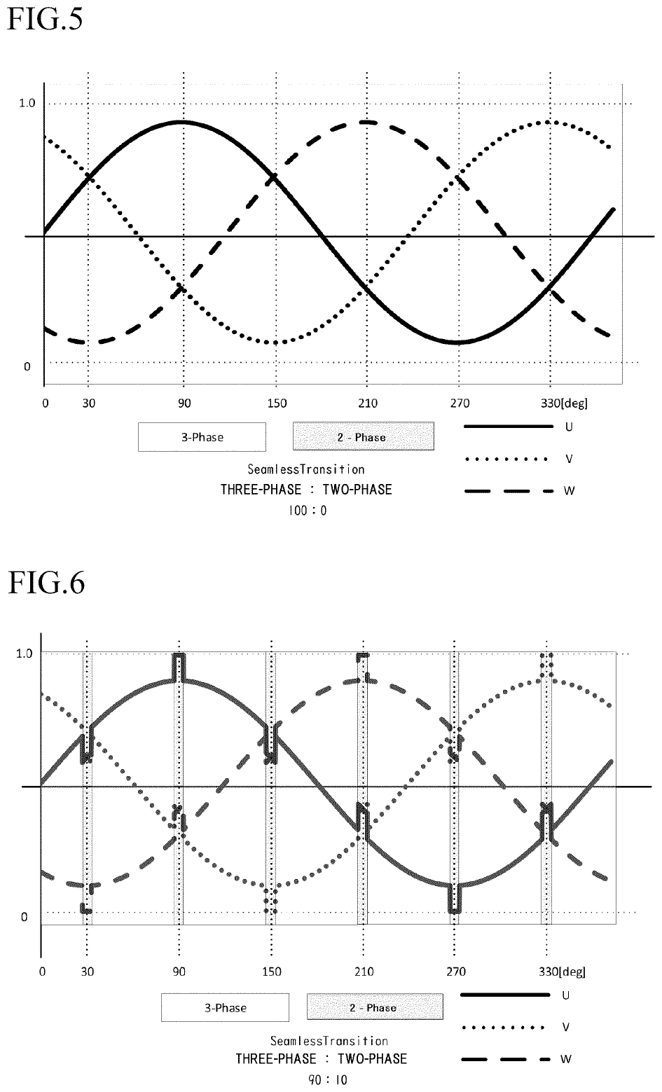

A specific example of the transitional operation mode will be described below. FIG. 5 illustrates average coil applied voltage waveforms with the mixture ratio between the three-phase modulation signal and the two-phase modulation signal being 100:0 during a single rotation of the three-phase brushless motor. Only the three-phase modulation signal is output in an electrical angle interval unit of 60 degrees.

FIG. 6 illustrates average coil applied voltage waveforms with the mixture ratio between the three-phase modulation signal and the two-phase modulation signal being 90:10 during a single rotation of the three-phase brushless motor. In an electrical angle interval unit of 60 degrees, the two-phase modulation signal is slightly mixed, with the proportion of the three-phase modulation signal being large.

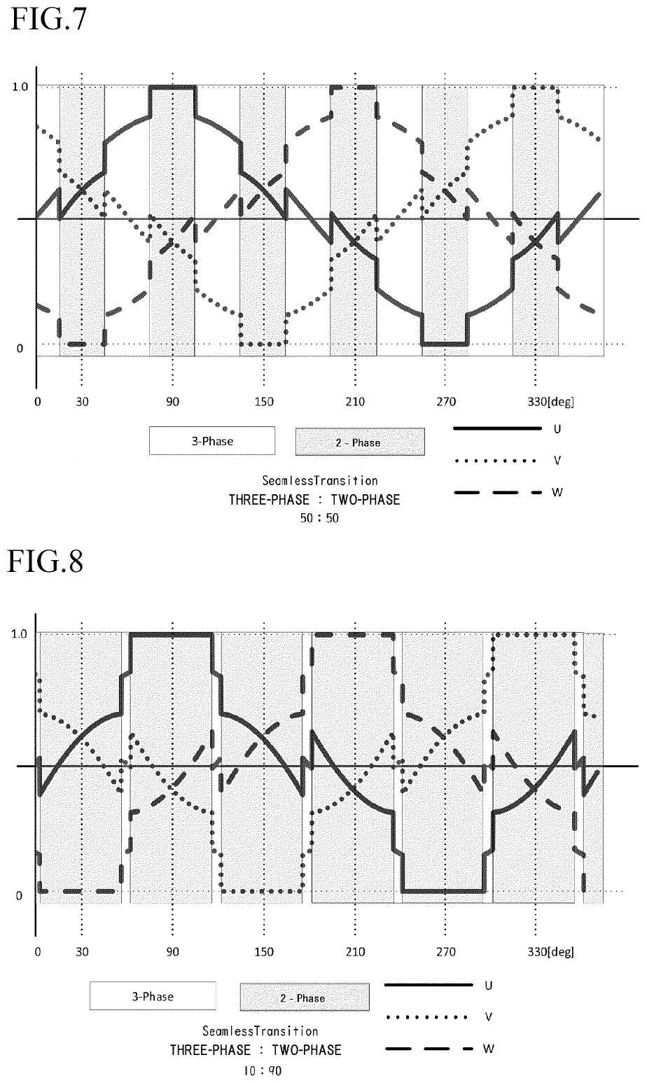

FIG. 7 illustrates average coil applied voltage waveforms with the mixture ratio between the three-phase modulation signal and the two-phase modulation signal being 50:50 during a single rotation of the three-phase brushless motor. In an electrical angle interval unit of 60 degrees, the three-phase modulation signal and the two-phase modulation signal are output with the ratio therebetween being 50:50.

FIG. 8 illustrates average coil applied voltage waveforms with the mixture ratio between the three-phase modulation signal and the two-phase modulation signal being 10:90 during a single rotation of the three-phase brushless motor. In an electrical angle interval unit of 60 degrees, the three-phase modulation signal is slightly mixed, with the proportion of the two-phase modulation signal being large.

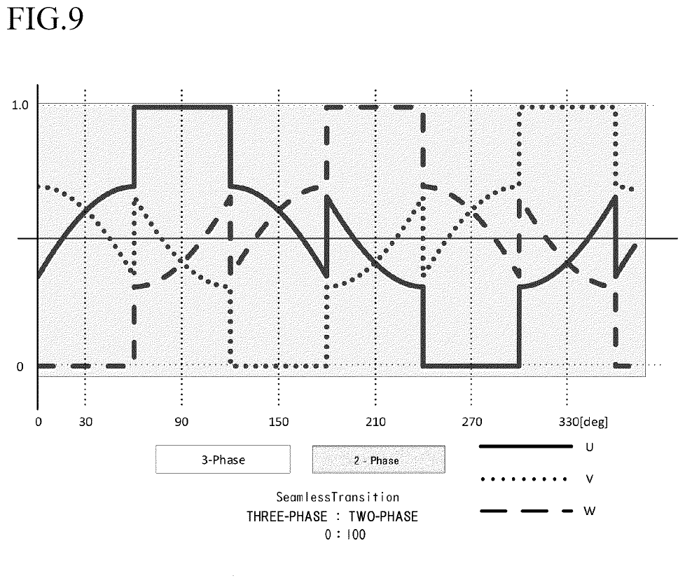

FIG. 9 illustrates average coil applied voltage waveforms with the mixture ratio between the three-phase modulation signal and the two-phase modulation signal being 0:100 during a single rotation of the three-phase brushless motor. Only the two-phase modulation signal is output in an electrical angle interval unit of 60 degrees.

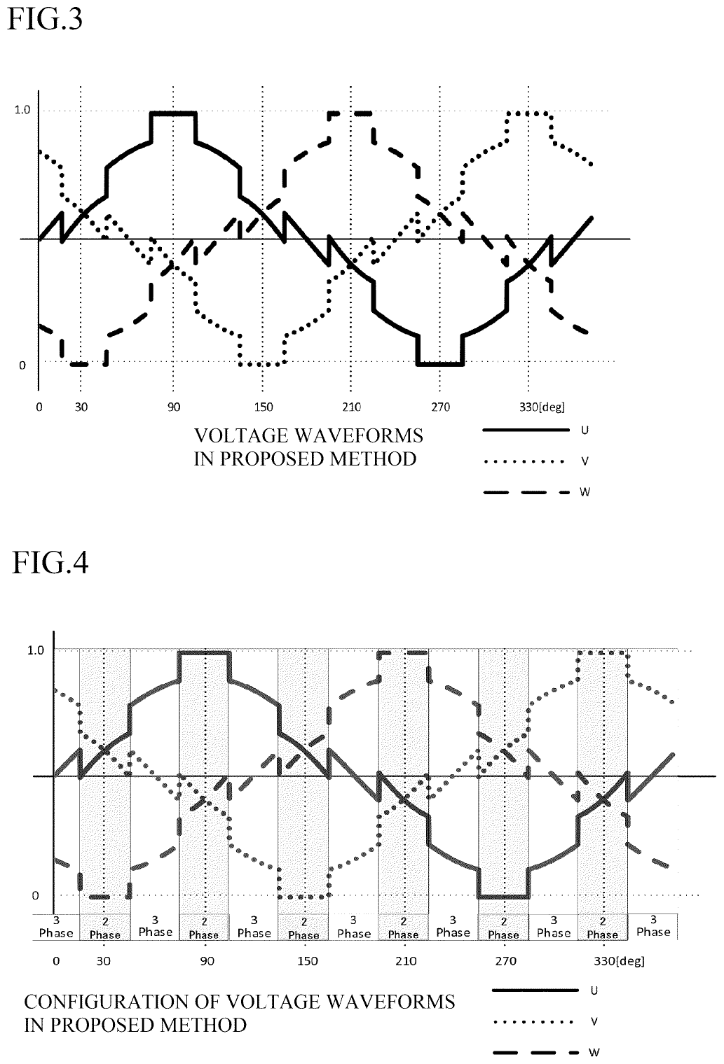

As can be seen in FIG. 3 and FIG. 4 that are diagrams illustrating the average coil applied voltage waveforms, under the transitional operation mode, the three-phase modulation signal and the two-phase modulation signal are alternately output in an electrical angle interval unit of 60 degrees, which is the energization interval, with the energization waveforms of the three-phase modulation signal and the two-phase modulation signal output being symmetrical about the center of the electrical angle interval of 60 degrees, which is the energization interval.

Thus, under the transitional operation mode, the fluctuation due to an interphase voltage difference in the three-phase coils caused by the switching between the three-phase modulation signal and the two-phase modulation signal is balanced, whereby the operation can be switched with the motor driven in a stable state.

Under the transitional operation mode as described above, the mixture ratio between the three-phase modulation signal and the two-phase modulation signal is changed among 100:0, 90:10, 50:50, 10:90, and 0:100. However, this should not be construed in a limiting sense, and the change can be made sharper or milder by setting the mixture ratio as appropriate. Furthermore, the average coil applied voltage waveforms under the transitional operation can be directly used for driving the motor, whereby a seamless transitional operation as a whole can be achieved.

As described above, when the operation of the three-phase motor is switched between the three-phase modulation operation mode and the two-phase modulation operation mode using the pulse width modulation method, the control circuit 4 transitions to the transitional operation mode in response to the reference signal set in advance, and outputs to the inverter circuit 2, the transition modulation signal with the mixture ratio between the three-phase modulation signal and the two-phase modulation signal gradually changed in a predetermined electrical angle interval unit. Thus, the operation can be switched smoothly, whereby the motor can be stably driven even under a loaded state.

While an example of the motor driving method is described in which the startup operation is performed under the three-phase modulation operation mode, and in response to the reference signal (for example, the motor rotation speed) set in advance, the operation is switched to the transitional operation mode, and then to the two-phase modulation operation mode corresponding to a high speed or load, the reference signal may trigger a transition from the two-phase modulation operation mode to the transitional operation mode and to the three-phase modulation operation mode.

The reference signal triggering the operation switching is not limited to the motor rotation speed, and a duty ratio of the PWM control pulse of the three-phase modulation signal or the two-phase modulation signal, a motor temperature acquired by a temperature sensor (not illustrated), and the like may be used as the reference for performing the switching.

The motor 1 is of a three-phase type, and the average coil applied voltage waveforms are basically a sine wave and thus includes positive and negative phase ranges. Thus, in the embodiment described above, an electrical angle of 60 degrees (=electrical angle, a single rotation 360 degrees/three phases/2) is selected as a predetermined electrical angle interval unit. The energization waveforms of the three-phase modulation signal and the two-phase modulation signal output are symmetrical about the center of the electrical angle interval of 60 degrees, which is the energization interval.

### First Modification

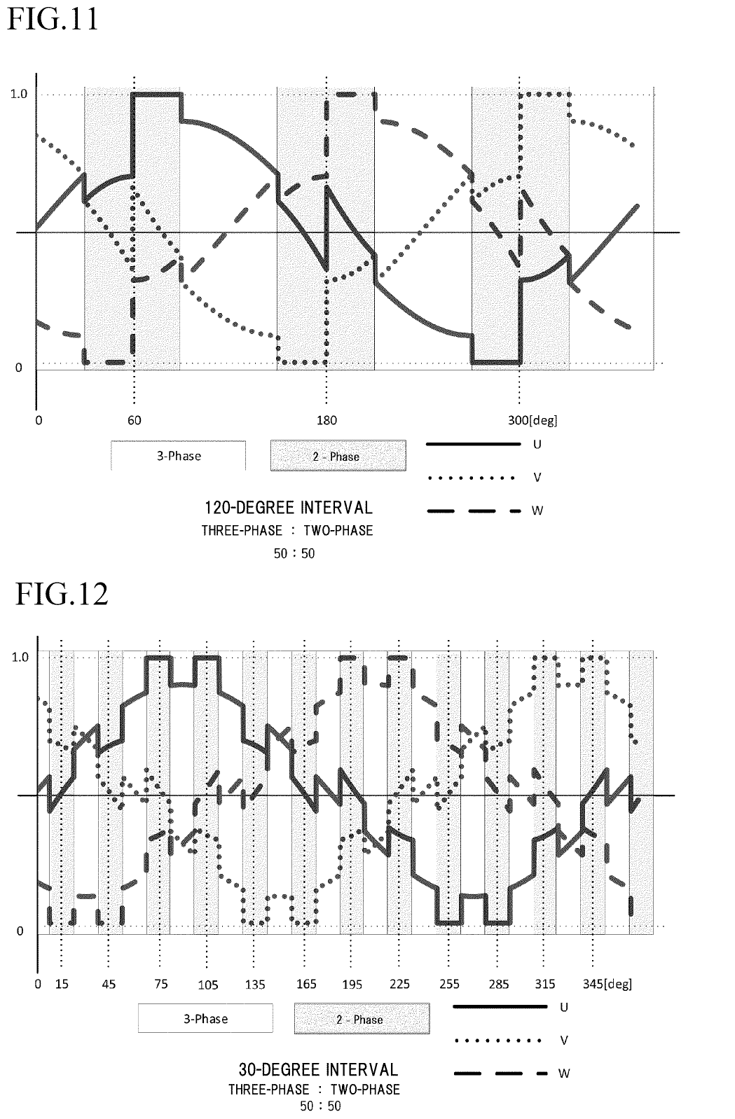

The unit energization interval may be a predetermined electrical angle other than an electrical angle of 60 degrees. For example, as illustrated in FIG. 11, the unit energization interval may be an electrical angle of 120 degrees. When the switching between the two-phase modulation and the three-phase modulation thus implemented less frequently compared with the case where the unit energization interval is an electrical angle of 60 degrees, the number of minute torque ripples per rotation before and after the modulation switching is reduced, unnecessary vibration frequencies can be shifted to a lower band, so that resonance with a load with a natural frequency can be avoided. Furthermore, with the switching between the two-phase modulation and the three-phase modulation occurring less frequently, unwanted radiation due to harmonics of the motor coil current can be reduced.

### Second Modification

FIG. 12 illustrates yet another example where the unit energization interval is set to an electrical angle of 30 degrees. With the switching between the two-phase modulation and the three-phase modulation thus implemented more frequently compared with the case where the unit energization interval is an electrical angle of 60 degrees, smooth motor rotation can be achieved with the minute torque ripples before and after the modulation switching further reduced, and unnecessary vibration frequencies can be shifted to a higher band, so that resonance with a load with a natural frequency can be avoided. Furthermore, with the switching between the two-phase modulation and the three-phase modulation occurring less frequently, unwanted radiation due to harmonics of the motor coil current can be reduced.

As described above, the predetermined electrical angle to be the unit energization interval can be any angle other than 60 degrees, such as 30 degrees, 90 degrees, 120 degrees, 180 degrees, and 360 degrees. The angle can be selected as appropriate in accordance with the property required for the motor control, and a difference in the number of poles, winding, connection method, and the like of the motor.

The motor driving method described above is suitably used for a voltage-type inverter control system such as an inverter air conditioner, inverter household appliance, and compressor for example.

What is claimed is:

1. A motor driving method of driving a three-phase motor including a stator with three-phase coils, through sine wave energization using a pulse width modulation method, the three-phase motor including an inverter circuit including an output element including a pair of a high-side arm and a low-side arm for each of three phases, and configured to perform an output to two phases of the three-phase coils, and a control circuit configured to control an output to the inverter circuit using a pulse width modulation energization method at a predetermined duty ratio based on an output command from an external command apparatus, the control circuit having a three-phase modulation operation mode under which a three-phase modulation signal is output to the inverter circuit as a pulse width modulation signal, a two-phase modulation operation mode under which a two-phase modulation signal is output to the inverter circuit as the pulse width modulation signal, and a transitional operation mode under which one of the three-phase modulation operation mode and the two-phase modulation operation mode is switched to the other, the method comprising, by the control circuit:
transitioning to the transitional operation mode in response to a reference signal set in advance; and
switching an operation by outputting to the inverter circuit, a transition modulation signal with a mixture ratio between the three-phase modulation signal and the two-phase modulation signal being gradually changed in a predetermined electrical angle interval unit.

2. The motor driving method according to claim 1 further comprising, by the control circuit:
in the transitional operation mode, alternately outputting the three-phase modulation signal and the two-phase modulation signal in a predetermined energization interval unit, with an energization waveform of the three-phase modulation signal or the two-phase modulation signal output being symmetrical about center of the predetermined energization interval.

3. The motor driving method according to claim 1 further comprising, by the control circuit:
generating the three-phase modulation signal and outputting the three-phase modulation signal to the inverter circuit at time of startup; and
outputting, when a rotation speed, load, or temperature becomes high, the two-phase modulation signal as a result of the transitional operation mode, to the inverter circuit.

4. The motor driving method according to claim 2 further comprising, by the control circuit:
generating the three-phase modulation signal and outputting the three-phase modulation signal to the inverter circuit at time of startup; and
outputting, when a rotation speed, load, or temperature becomes high, the two-phase modulation signal as a result of the transitional operation mode, to the inverter circuit.
